(19) United States
(12) Patent Application Publication
(10) Pub. No.: US 2012/0079335 A1
(43) Pub. Date: Mar. 29, 2012

(54) Large scale parallel computing system

(76) Inventors: Xianghui Wang, Fremont, CA (US); Wensheng Hua, Fremont, CA (US)

(21) Appl. No.: 13/246,853

(22) Filed: Sep. 27, 2011

Related U.S. Application Data
(60) Provisional application No. 61/386,573, filed on Sep. 27, 2010.

(51) Int. Cl. G06F 15/16; G06F 11/00

(52) U.S. Cl. 714/746; 709/201; 714/E11.007; 714/E11.001

(57) ABSTRACT

A new computer system is invented for handling large scale calculation.

### CROSS REFERENCE TO RELATED APPLICATIONS

The present application is related to, and claims priority of, provisional patent application, entitled: “A large scale parallel computing system”, with Ser. No. 61/386,573, filed on Sep. 27, 2010. The provisional patent application is hereby incorporated by reference in its entirety.

### DESCRIPTION

A new computer system is invented for handling large scale calculation. The computer system (contains a lot of parallel computers) maintains an array of states X(n). In each step, the computer system operates on the states to generate output Y(n), and updates the states to X(n+1).

X(n+1)=F(X(n)) (1)

Y(n)=G(X(n)) (2)

In preferred embodiments, function G(·) and F (·) are parallel-able.

$${x}_{0} = {f}_{0} ( X ) \\ {x}_{1} = {f}_{1} ( X ) \\ … \\ {x}_{k} = {f}_{k} ( x ) \qquad ( 3 )$$

Here, χ₀, χ₁, . . . , χₖ are sub-arrays of X and X=[χ₀^{T}, χ₁^{T}, . . . , χₖ^{T}]^{T}. Hence, F(·) can be parallelized. Each computing unit can take one or more sub-operators from ƒ₀, ƒ₁, . . . , ƒₖ. Similarly, we can parallelize G(·) into sub-operators g₀, g₁, . . . gₖ. The computer system operates in the following way.

1, a central controller broadcast the current states to each computing unit.

2, each computing unit calculate one (or many) of the sub-operators

3, the computing units sends the updated states to the central controller

4, repeat step 1 until the task is done.

In many computer systems, the bottleneck of these steps is in communication steps, i.e. step 1 and step 3.

Particularly, step 1 could be very time consuming if it is not well implemented. For example, if the central controller has to send the states to each computing unit, the total amount of data it has to send is: N×M, where N is the number of states and M is the number of computing units.

To solve the problem we need to use advanced network topology and data delivery algorithms to reduce the amount of time spent on data communication. In preferred embodiments, the number of hops need to for a data packet to reach each computational node is in order of log(M). Also, it is preferred that data lose is recovered between the nodes without asking the central controller to to retransmit. For example, we can use the data broadcasting method proposed by patent application “BALANCED NETWORK AND METHOD” with Application Ser. No. 11/623,045, and let the control controller attached to the root and computing units attached to the other nodes. Sending data from computing units to the central controller in step 3 is an problem relatively easy to solve. Even if each computing unit sends data in-dependently to the central controller only need to receive N numbers for each iteration. However, a better way of doing it is that, when “BALANCED NET-WORK AND METHOD” with Application Ser. No. 11/623,045 is used, each node sends its updated states and the updated states it receives from its descendant to its parent in the same group. Finally the top node in each group will send the updated states to the root.

The output data can be sent to the central controller in a similar way or can be stored at each computing unit and collected later.

Matrix vector multiplication

One application of the proposed system is to do scale parallel calculation of matrix vector multiplication.

X(n+1)=AX(n) (4)

Where A is a matrix. The sub-operators are groups of rows of A.

A=[α₀^{T}, α₁^{T}, . . . , αₖ^{T}]^{T} (5)

Note that A can be a sparse matrix too. Matrix vector multiplication is the building block of many very useful algorithms such as PageRank, SVD, optimization (many gradient methods) and solving linear equation (such as conjugate gradient method) etc. Solving linear equation is in-turn the building block of solving differential equation, simulate dynamic systems, optimization, etc. The proposed system in fact has very broad usage, for examples, weather forecast, investment optimization, fraud detection, and many many more.

1. A parallel computer system that consist of:
a central controller,
one or more computational units,
a communication network that connects the central controller and the computational unites,
data are send from the central controller to computational units for data processing and the data processing results are collected back to the central controller.

2. a parallel computer system as in claim 1, wherein the data from central controller are sent to the computational units using multicast

3. a parallel computer system as in claim 2, the number of hops need to for a data packet to reach each computational node is in order of log(M)

4. a parallel computer system as in claim 2, data lose is recovered between the nodes without asking the central controller to to retransmit

5. a parallel computer system as in claim 2, wherein the parallel calculation is done by repetitively multicast, distributed calculate, data collection.
